(19) United States
(12) Patent Application Publication
(10) Pub. No.: US 2023/0335710 A1
(43) Pub. Date: Oct. 19, 2023

(54) Bipolar Electrode and Bipolar Storage Battery

(71) Applicants: Furukawa Electric Co., Ltd., Tokyo (JP); The Furukawa Battery Co., Ltd., Yokohama (JP)

(72) Inventors: Yasuo Nakajima, Tokyo (JP); Hiroki Tanaka, Tokyo (JP); Kenichi Suyama, Tokyo (JP); Akira Tanaka, Tokyo (JP); Yoshinobu Taira, Iwaki (JP); Kenji Hirota, Iwaki (JP); Satoshi Shibata, Iwaki (JP)

(21) Appl. No.: 18/330,668

(22) Filed: Jun. 7, 2023

Related U.S. Application Data
(63) Continuation of application No. PCT/JP2021/039488, filed on Oct. 26, 2021.

(30) Foreign Application Priority Data
Dec. 10, 2020 (JP) 2020-204830

(51) Int. Cl. H01M 4/14

(52) U.S. Cl. CPC H01M 4/14; H01M 2004/029

(57) ABSTRACT

A bipolar electrode for a bipolar lead-acid battery includes a base plate with a conduction through hole, a positive electrode stuck to a first surface of the base plate with an adhesion layer, and a negative electrode stuck to a second surface of the base plate with an adhesion layer. The bipolar electrode includes a conductor disposed in the through hole and has a bonding portion to which the positive electrode is electrically bonded on a first surface of the conductor and has a bonding portion to which the negative electrode is electrically bonded on a second surface of the conductor. The conductor has a projecting portion surrounding the periphery of the bonding portion on both the first surface and the second surface. By preventing contamination of the bonding portion with an adhesive, the bonding reliability between a positive electrode lead layer and a negative electrode lead layer is improved.

### CROSS-REFERENCE TO RELATED APPLICATION(S)

This application is a continuation of PCT Application No. PCT/JP2021/039488, filed Oct. 26, 2021, the disclosure of which is incorporated herein in its entirety by reference.

### TECHNICAL FIELD

The present invention is a technology relating to a bipolar storage battery.

### BACKGROUND

For example, in a bipolar lead-acid battery, a plurality of bipolar electrodes is stacked via electrolyte layers, a positive electrode being formed on a first surface of a base plate (bipolar plate) and a negative electrode being formed on a second surface of the base plate in each of the plurality of bipolar electrodes.

A bipolar lead-acid battery described in JP Patent Publication No. 2004-179053 A is a bipolar lead-acid battery in which bipolar electrodes are stacked via gel electrolyte layers, a positive active material layer is formed on a first surface of a current collector, and a negative active material layer is formed on a second surface in each of the bipolar electrodes. JP Patent Publication No. 2004-179053 A mentions a bipolar battery including a double-sided adhesive member disposed to surround the periphery of a single cell layer including a positive active material layer, a gel electrolyte layer, and a negative active material layer adjacently provided, in which the double-sided adhesive member is composed of an insulating material serving as a base material and an adhesive provided on both surfaces of the insulating material. The double-sided adhesive member is sandwiched between two current collectors together with the single cell layer and is adhered to the two current collectors by the adhesive.

In addition, in a bipolar lead-acid battery described in JP Patent Publication No. 6124894 B2, a base plate (bipolar plate) made of a resin is attached inside a frame (rim) made of a resin having a frame shape. A positive electrode lead layer and a negative electrode lead layer are provided on a first surface and a second surface of the base plate. The positive electrode lead layer and the negative electrode lead layer are directly bonded in a plurality of through holes formed in the base plate. That is, JP Patent Publication No. 6124894 B2 mentions a bipolar lead-acid battery in which a plurality of base plates (bipolar plates) each having a through hole for communicating one surface side and the other surface side and a plurality of cell members are alternately stacked. A cell member includes a positive electrode in which a positive active material layer is provided on a positive electrode lead layer, a negative electrode in which a negative active material layer is provided on a negative electrode lead layer, and an electrolyte layer interposed between the positive electrode and the negative electrode, and the cell members are connected in series by immersing and bonding the positive electrode lead layer of one cell member and the negative electrode lead layer of the other cell member in the through hole (communication hole) of the base plate.

### SUMMARY

Each of the bipolar electrodes described in JP Patent Publication Nos. 2004-179053 A and 6124894 B2 has a structure in which lead layers (pieces of lead foil) forming a positive electrode and a negative electrode are bonded individually to a first surface and a second surface of a base plate by a liquid adhesive, and the liquid adhesive is hardened to entirely fix the lead layer to the surface of the base plate by means of an adhesion layer.

However, in a case where a through hole for providing conduction between the positive electrode and the negative electrode is formed in the base plate and a columnar conductor is disposed in the through hole as described in JP Patent Publication No. 6124894 B2, there is a problem that an adhesive applied to the surface of the base plate spreads along the surface of the base plate at the time of bonding the lead layers and consequently the surface of the conductor disposed in the through hole may be contaminated with the adhesive. In particular, the adhesive more easily flows into a bonding portion of the conductor as it is attempted to obtain a more sufficient bonding area and a more sufficient bonding strength between the base plate and the lead foil.

Then, if the conductor placed in the conduction through hole is contaminated with the adhesive, conduction between the positive electrode lead layer and the negative electrode lead layer through the conductor is not possible, or a conduction area (welding area) is reduced. If such an event occurs, there is a problem that electric resistance between the positive electrode lead layer and the negative electrode lead layer increases.

The present invention has been made in view of the above points, and an object of the present invention is to improve the reliability of bonding between a positive electrode lead layer and a negative electrode lead layer by preventing contamination of a bonding portion of a conductor with an adhesive.

To solve the problems, a bipolar electrode for a bipolar storage battery according to a first aspect of the present invention includes a bipolar plate in which a conduction through hole is formed, a positive electrode stuck to a first surface of the bipolar plate with an adhesion layer, and a negative electrode stuck to a second surface of the bipolar plate with an adhesion layer. The bipolar electrode includes a conductor disposed in the through hole of the bipolar plate, a bonding portion to which the positive electrode is electrically bonded on a first surface of the conductor, and a bonding portion to which the negative electrode is electrically bonded on a second surface of the conductor. The conductor has a projecting portion surrounding the periphery of the bonding portion on each of the first surface and the second surface.

In addition, a second aspect of the present invention is a bipolar storage battery including the bipolar electrode of the first aspect.

According to embodiments of the present invention, the projecting portion provided on the periphery of the bonding portion prevents an adhesive constituting an adhesion layer from entering the bonding portion in a conduction through hole. As a result, according to embodiments of the present invention, for example, it is possible to improve the reliability of bonding of a positive electrode lead layer and a negative electrode lead layer via the conductor disposed in the through hole.

In other words, by providing the projecting portion on the periphery of the bonding portion of the conductor, it is possible to prevent the bonding portion on the conductor from being contaminated with the applied adhesive when the lead layer (lead foil) is fixed to the surface of the bipolar plate by the adhesion layer made of the adhesive. In addition, even after the lead layer is bonded to the surface of the bipolar plate with the adhesion layer, the adhesion layer near the through hole becoming fluid and contaminating the bonding portion on the conductor due to resistance welding for bonding the positive electrode lead layer and the negative electrode lead layer through the conductor provided in the through hole is avoided.

Here, if the adhesive is positioned on a surface of the conductor, there is a possibility that welding that forms the bonding portion will be disturbed and electric resistance between the lead layers will be increased. In this regard, in embodiments of the present invention, because the bonding portion on the conductor is not contaminated, reliability when welding for forming the bonding portion is improved. As a result, the bipolar storage battery including the bipolar electrode according to embodiments of the present invention can achieve both long-term reliability and high energy density.

The adhesion layer is formed by curing a liquid adhesive. In this configuration, when the lead layer is bonded to the bipolar plate, the entry of the adhesive into the bonding portion on the conductor can be prevented by the projecting portion.

A height of the projecting portion is more than or equal to a thickness of the adhesion layer. In this configuration, the projecting portion is equal to or higher than the height of the adhesion layer, and the bonding portion on the conductor can be more reliably prevented from being contaminated with the adhesive.

The projecting portion has a height of 20 μm or more and 500 μm or less (i.e., the projecting portion has a height between 20 μm or more and 500 μm, inclusive. In this configuration, it is possible to suppress an amount of projection of the projecting portion to a lead layer side with respect to the adhesion layer and to suppress a load by the projecting portion to the lead layer while the projecting portion prevents bonding on the conductor from being contaminated with the adhesive.

The projecting portion is formed integrally with the conductor. In this configuration, the projecting portion can be formed when the conductor is produced.

The projecting portion is a part separate from the conductor and adheres to the surface of the conductor. In this configuration, the projecting portion is positioned by simply adhering the projecting portion, and the projecting portion can be easily formed.

The projecting portion is an adhesion seal having an adhesive layer at least on a conductor-side surface. In this configuration, the projecting portion is positioned by simply adhering the projecting portion with the adhesive layer, and the projecting portion can be easily formed.

The projecting portion is formed by a liquid gasket. In this configuration, the projecting portion is positioned by simply adhering the liquid gasket, and the projecting portion can be easily formed.

A bipolar storage battery capable of achieving both long-term reliability and high energy density can be provided by the effects described above.

### BRIEF DESCRIPTION OF THE DRAWINGS

FIG. 1 is a cross-sectional view illustrating a structural example of a bipolar lead-acid battery according to an embodiment based on the present invention.

FIG. 2 is a plan view illustrating a base plate (bipolar plate) according to an embodiment based on the present invention.

FIG. 3 is a cross-sectional view of a through hole of FIG. 2 illustrating an example of a bonding structure of a positive electrode lead layer and a negative electrode lead layer.

FIG. 4 is a cross-sectional view illustrating another example of a projecting portion.

### DETAILED DESCRIPTION

Embodiments of the present invention are described with reference to the drawings.

Here, the same components are described with the same reference signs unless otherwise noted. In addition, in each drawing, a thickness and ratio of each component may be exaggerated, and the number of components may also be illustrated differently from those of the actual product. In addition, the present invention is not limited to the following embodiments as they are, and the present invention can be embodied by appropriate combinations or modifications without departing from the gist of the present invention, and forms in which such changes or improvements are added can also be included in the present invention.

Configuration

In the following description, a bipolar lead-acid battery is described as an example of a bipolar storage battery; however, the present disclosure is applicable also to a bipolar storage battery other than the bipolar lead-acid battery.

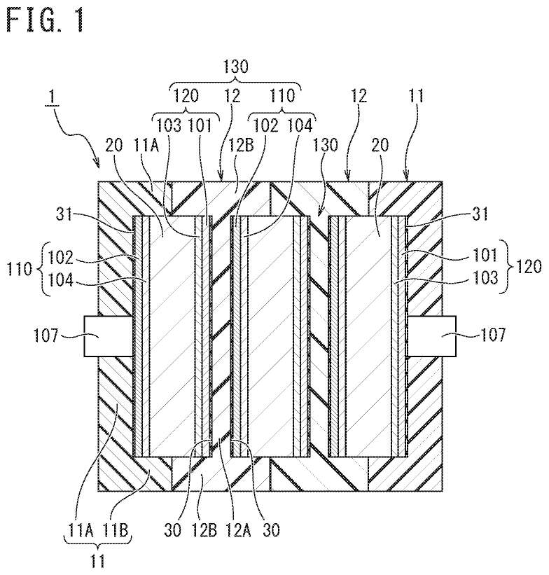

A structure of a bipolar lead-acid battery 1 of the present embodiment will now be described with reference to FIG. 1.

The bipolar lead-acid battery 1 illustrated in FIG. 1 is configured by stacking a plurality of bipolar electrodes 130 in a thickness direction via electrolyte layers 20. Electrolyte layers 20 are separately stacked on both ends in a stacking direction of the stacked bipolar electrode group. Then, the electrolyte layer 20 disposed on the left end in FIG. 1 is electrically connected to a negative electrode terminal 107 via a negative electrode 110, and the electrolyte layer 20 disposed on the right end in FIG. 1 is electrically connected to a positive electrode terminal 107 via a positive electrode 120. An adhesion layer 31 is for bonding the negative electrode 110 and the positive electrode 120 on an end side in the stacking direction to a main body portion 11A (also called an end plate) of an external frame 11. The external frame 11 includes a plate-shaped main body portion 11A and a rising portion 11B rising from the entire outer peripheral portion of the main body portion 11A.

Here, the electrolyte layer 20, and the positive electrode 120 and the negative electrode 110 facing each other across the electrolyte layer 20 constitute one cell member. In the example of FIG. 1, the bipolar lead-acid battery 1 including two bipolar electrodes 130 and three cell members is illustrated. The number of cell members and the number of stacked bipolar electrodes 130 are set according to the required storage capacity of the bipolar lead-acid battery 1.

Bipolar Electrode 130

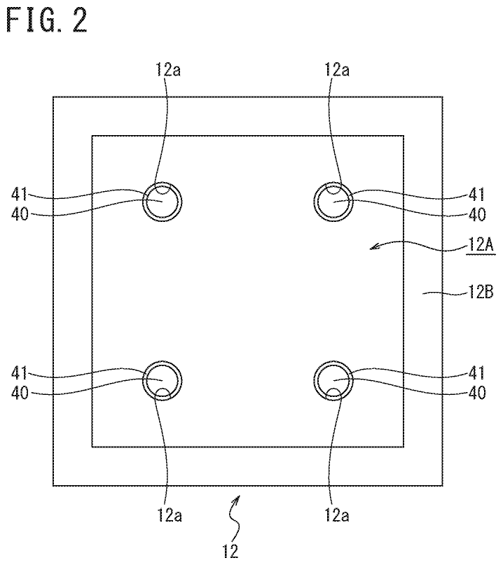

Referring to FIGS. 1 and 2, the bipolar electrode 130 includes an internal frame 12, a conductor 40, a positive electrode 120, and a negative electrode 110.

The internal frame 12 of the present embodiment is composed of a plate-like base plate 12A (bipolar plate) provided with electrodes on both surfaces and a frame member 12B (also called a rim) integrally connected to the entire outer peripheral portion of the base plate 12A. The frame member 12B rises from both surfaces of the base plate 12A in a thickness direction of the base plate 12A. Note that the internal frame 12 and the external frame 11 are made of, for example, a thermoplastic resin. Examples of the thermoplastic resin include an acrylonitrile-butadiene-styrene copolymer (ABS) resin or polypropylene. These thermoplastic resins are excellent in moldability and in sulfuric acid resistance. Therefore, even if an electrolytic solution contacts the base plate 12A, decomposition, deterioration, corrosion, etc., hardly occur in the base plate 12A.

In the present embodiment, a case where the frame member 12B is formed integrally with the base plate 12A is given as an example; however, the base plate 12A and the frame member 12B may be configured separately.

The frame members 12B of the internal frame 12 constitute a framework of the battery 1 accommodating a plurality of bipolar electrodes 130 together with a pair of external frames 11 disposed on both end sides in the stacking direction. Then, a space formed between adjacent internal frames 12 and a space formed between the adjacent internal frames 12 and the external frames 11 form a chamber (cell) for accommodating the cell member.

As illustrated in FIG. 1, the positive electrode 120 is bonded to a first surface 12Aa of the base plate 12A by an adhesion layer 30. The positive electrode 120 includes a positive electrode lead layer 101 and a positive active material layer 103 placed on the positive electrode lead layer 101. The positive electrode lead layer 101 is made of lead or a lead alloy, and has, for example, a foil shape (lead foil). The positive electrode lead layer 101 is bonded to the first surface 12Aa of the base plate 12A by an adhesive.

In addition, as illustrated in FIG. 1, the negative electrode 110 is bonded to a second surface 12Ab of the base plate 12A by an adhesion layer 30. The negative electrode 110 includes a negative electrode lead layer 102 and a negative active material layer 104 placed on the negative electrode lead layer 102. The negative electrode lead layer 102 is made of lead or a lead alloy, and has, for example, a foil shape (lead foil). The negative electrode lead layer 102 is bonded to the second surface 12Ab of the base plate 12A by an adhesive.

Conduction Portion

Here, as illustrated in FIG. 2, a plurality of through holes 12a for conduction is formed in the base plate 12A to bring the positive electrode lead layer 101 and the negative electrode lead layer 102 into conduction (electrically bonding them). FIG. 2 illustrates, as an example, a case where the cross-sectional shape of the through hole 12a is circular; however, the cross-sectional shape of the through hole 12a is not particularly limited and may be a polygonal shape or the like.

In the present embodiment, the conductor 40 is disposed in each through hole by insertion. The conductor 40 is composed of a conductive material such as a metal. For example, copper or an alloy may be used.

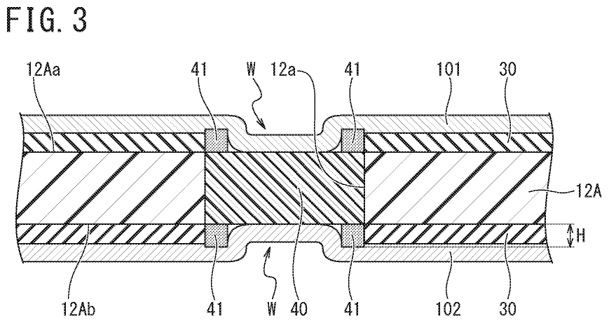

As illustrated in FIGS. 2 and 3, the conductor 40 of the present embodiment has a columnar shape (circular cylindrical shape in the present embodiment), and an upper surface (first surface) and a lower surface (second surface) of the conductor 40 are surfaces on which a bonding portion W electrically bonded to the lead layers is formed. A reference sign W in FIG. 3 indicates the position of the bonding portion. The shape of the conductor 40 is not particularly limited so long as the conductor 40 has an upper surface and a lower surface on which bonding portions are formed vertically.

In the present embodiment, a projecting portion 41 is formed on the upper surface and the lower surface of the conductor 40. In other words, as illustrated in FIGS. 2 and 3, each of the projecting portions 41 continuously extends along the outer peripheral portion of the upper surface and the lower surface of the conductor 40 without interruption and has an endless annular shape. In this example, the projecting portion 41 is assumed to be formed, for example, integrally with the conductor 40. Then, a surface surrounded by the projecting portion 41 is the bonding portion W bonded to the positive electrode lead layer 101 and negative electrode lead layer 102.

In the present embodiment, the adhesion layer 30 is assumed to be formed by applying a liquid adhesive to the surface of the base plate 12A. Then, the liquid adhesive is hardened to form the adhesion layer 30.

There is a possibility that the liquid adhesive applied to the surface of the base plate 12A will flow along the surface of the base plate 12A and contaminate the surface of the conductor 40 when bonding the positive electrode lead layer 101 and negative electrode lead layer 102. In particular as it is attempted to increase an adhesion area and an adhesion strength between the surface of the base plate 12A and each lead layer, an amount of the adhesive applied increases, and the adhesive is more easily positioned on the surface of the conductor 40.

In this regard, in the present embodiment, the endless annular projecting portion 41 continuously surrounding the periphery of each bonding portion W without interruption is formed. Therefore, the adhesive flowing toward the conductor 40 is less likely to flow toward a bonding portion W due to a step formed by the projecting portion 41, and easily flows toward other sides. Thereby, the amount of the adhesive adhered to the bonding portion W can be reduced.

A height H of the projecting portion 41 is preferably more than or equal to a thickness (equal to or higher than a height) of the adhesion layer 30. For example, the height H of the projecting portion 41 is set in the range of 20 μm or more and 500 μm or less. This is because the thickness of the adhesion layer 30 is, for example, about 20 μm to 30 μm.

In the present embodiment, a state in which the height H of the projecting portion 41 is more than or equal to the thickness of the adhesion layer 30 refers to a state in which the upper surface of the projecting portion 41 is flush with the upper surface of the adhesion layer 30 or protrudes from the upper surface of the adhesion layer 30.

By setting the height H of the projecting portion 41 to be more than or equal to the thickness of the adhesion layer 30, the adhesive flowing toward the through hole 12a is prevented from flowing toward a side of the through hole 12a by the projecting portion 41, and the adhesive can be prevented from entering the bonding portion W.

In addition, conduction between the positive electrode lead layer 101 and the negative electrode lead layer 102 is executed by, for example, resistance welding, and as in FIG. 3, the positive electrode lead layer 101 and the negative electrode lead layer 102 are electrically bonded through the conductor 40. At the time of this welding resistance, even if the adhesion layer 30 in the vicinity of the through hole 12a is melted by the heat of the welding resistance and has fluidity, in the present embodiment the projecting portion 41 can prevent the adhesive having fluidity from flowing into the bonding portion W.

Here, if the height H (projecting amount) of the projecting portion 41 is higher than the thickness of the adhesion layer 30, the bonded positive electrode lead layer 101 and negative electrode lead layer 102 may experience deformation such as bending due to the top of the projecting portion 41, and a load may be applied to the bonded positive electrode lead layer 101 and negative electrode lead layer 102. From this point of view, the height H of the projecting portion 41 is preferably, for example, 500 μm or less. More preferably, the height H of the projecting portion 41 has a difference from the height of the adhesion layer 30 of 50 μm or less, and further 20 μm or less. Usually, a thickness of the lead layer is 70 μm or more, and the difference between the height H of the projecting portion 41 and the height of the adhesion layer 30 is preferably less than the thickness of the lead layer.

In addition, a width DO of the projecting portion 41 is, for example, set in the range of 0.5 mm or more and preferably 1.0 mm or less.

Considering that the bonding portion W is formed inside the projecting portion 41, the width DO of the projecting portion 41 is preferably small to secure a predetermined area of the bonding portion W. The upper limit of the width DO of the projecting portion 41 is limited from an area required as the bonding portion W. Note that the diameters of the through hole 12a and the conductor 40 may be increased according to the width of the projecting portion 41.

Note that in FIG. 3, the outer peripheral surface of the conductor 40 and the outer peripheral surface of the projecting portion 41 are formed to be flush with each other; however, the present invention is not limited to this. The outer peripheral surface position of the projecting portion 41 may be disposed outside the outer peripheral surface of the conductor 40. In addition, the outer peripheral surface position of the projecting portion 41 may be disposed to be positioned inside the outer peripheral surface of the conductor 40.

Adhesion Layer

As described above, the adhesion layer 30 is formed between the base plate 12A and the positive electrode lead layer 101 and negative electrode lead layer 102. The adhesive used for the adhesion layer 30 and adhesion layer 31 preferably has sulfuric acid resistance. Examples of the adhesive include an epoxy-based adhesive. The epoxy-based adhesive contains an epoxy resin as a main agent, and an acidic or basic hardening agent can be used as a hardening agent. Examples of the epoxy resin contained in the main agent include, but are not limited to, a bisphenol A type epoxy resin, a bisphenol F type epoxy resin, and the like.

Electrolyte Layer 20

The electrolyte layer 20 is made of, for example, a glass fiber mat impregnated with an electrolytic solution containing sulfuric acid.

### MODIFICATION EXAMPLES

(1) In the above description, a case where the projecting portion 41 is formed integrally with the conductor 40 has been given as an example, but the present invention is not limited to this.

A projecting portion 41 may be configured separately from a conductor 40, and the projecting portion 41 may be configured to be bonded to the conductor 40 before the positive electrode lead layer 101 and negative electrode lead layer 102 are bonded to the base plate 12A with an adhesive.

For example, the projecting portion 41 is formed of an adhesion seal having an adhesive layer on at least one surface. Then, the adhesion seal is adhered to the surface of the conductor 40 by adhesion to form the projecting portion 41.

The adhesion seal may have adhesive layers on both surfaces. In this case, the adhesion seal also adheres to the surfaces of the positive electrode lead layer 101 and negative electrode lead layer 102, and the adhesion seal also has a role of fixing the lead layers to the base plate 12A.

Here, the adhesion seal is composed of a base material and an adhesive layer. Examples of the base material include, but are not limited to, polyesters, polyolefins, polyimide films, and fluorine (Teflon®) films. In addition, as a material of the adhesive layer, for example, a rubber-based, acrylic-based, or silicone-based adhesive can be used. The adhesion seal is not limited to this, and other adhesion seals may be used.

In addition, regarding bonding of the adhesion seal to the base plate 12A, for example, after the adhesion seal is bonded to cover the through hole 12a, a portion overlapping with the through hole 12a may be hollowed out to form the projecting portion 41.

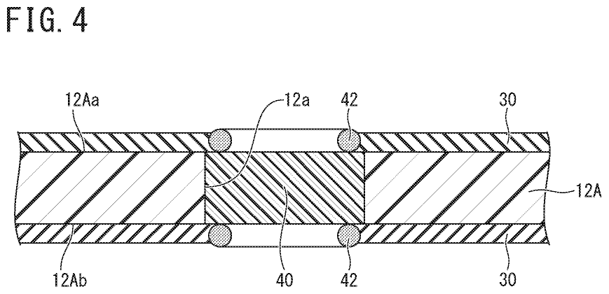

In addition, as in FIG. 4, a projecting portion 42 may also be formed by adhering a liquid gasket to the outer peripheral portion of the surface of the conductor 40. It is preferable to form a recess on a surface on which the liquid gasket is to be formed, in view of facilitating the disposition of the liquid gasket.

(2) In addition, FIG. 3 illustrates, as an example, a case where the shape of the vertical end surface of the projecting portion 41 is rectangular; however, the present invention is not limited to this.

For example, the projecting portion 41 may be rounded in an arc shape to give curvature to a corner portion of the projecting portion 41, or the side surface of the projecting portion 41 may be inclined to make the angle of the corner portion obtuse. In addition, the top portion itself of the projecting portion 41 may be formed to have an arc cross section. The cross-sectional shape of the projecting portion 41 is not particularly limited.

In the case of this modification example, a load by the projecting portion 41 on the lead layer to be bonded can be reduced.

(3) Here, the projecting portion 41 may be formed of the same material (conductive material) as a material of the conductor 40.

In this case, contact portions between the projecting portion 41 and the positive electrode lead layer 101 and between the projecting portion 41 and the negative electrode lead layer 102 also constitute conduction portions.

(4) The above description has been given on the assumption that a thickness (height) of the conductor 40 is equal to the thickness of the base plate 12A.

The thickness (height) of the conductor 40 may be larger than the thickness of the base plate. In this case, the height of the projecting portion 41 can be suppressed to be low by the increased thickness of the conductor 40.

(5) In addition, apart from the projecting portion 41 formed on the conductor 40, an endless annular projecting portion or a groove portion continuously surrounding the periphery of the through hole 12a without interruption may be provided on the surface of the base plate 12A. The projecting portion or the groove portion is formed preferably in a region within 10 mm from the through hole 12a, the periphery of the through hole 12a is to be surrounded by the projecting portion in a planar view. The projecting portion and the groove portion formed on the base plate 12A do not need to have an endless annular shape.

Others

The present disclosure can also have the following configurations.

(1) A bipolar electrode for a bipolar storage battery that includes a base plate in which a conduction through hole is formed, a positive electrode stuck to a first surface of the base plate with an adhesion layer, and a negative electrode stuck to a second surface of the base plate with an adhesion layer. The bipolar electrode includes a conductor disposed in the through hole of the base plate, a bonding portion to which the positive electrode is electrically bonded on a first surface of the conductor, and a bonding portion to which the negative electrode is electrically bonded on a second surface of the conductor. The conductor has a projecting portion surrounding the periphery of the bonding portion on each of the first surface and the second surface.

In this configuration, the projecting portion is provided, whereby contamination of the bonding portion W on the conductor 40 with the applied adhesive is prevented when fixing the lead layer (lead foil) to the surface of the base plate 12A with the adhesion layer 30 made of the adhesive. In addition, even after the lead layer is bonded to the surface of the base plate 12A with the adhesion layer 30, the adhesion layer 30 near the through hole 12a becoming fluid and contaminating the bonding portion W on the conductor 40 due to resistance welding for bonding the positive electrode lead layer 101 and the negative electrode lead layer 102 through the conductor 40 in the through hole 12a is avoided.

Here, if the adhesive is positioned on the surface of the conductor 40, there is a possibility that welding that forms the bonding portion will be disturbed and electrical resistance between the lead layers will increase. In this regard, in the present embodiment, because the bonding portion on the conductor is not contaminated, the reliability when welding for forming the bonding portion is improved. As a result, a bipolar storage battery including the bipolar electrode of the present embodiment can achieve both long-term reliability and high energy density.

(2) The adhesion layer is formed by curing a liquid adhesive.

In this configuration, when the lead layer is bonded to the base plate, the entry of the adhesive into the bonding portion on the conductor can be prevented by the projecting portion.

(3) A height of the projecting portion is more than or equal to a thickness of the adhesion layer.

In this configuration, the bonding portion W on the conductor can be more reliably prevented from being contaminated with the adhesive.

(4) The projecting portion has a height of 20 μm or more and 500 μm or less.

In this configuration, a load on the lead layer by the projecting portion can be suppressed while preventing the contamination of the bonding portion W on the conductor with the adhesive.

(5) The projecting portion is formed integrally with the conductor.

In this configuration, the projecting portion can be formed when the conductor is produced.

(6) The projecting portion is a part separate from the conductor and adheres to the surface of the conductor.

In this configuration, the projecting portion is positioned by simply performing adhesion, and the projecting portion can be easily formed.

(7) The projecting portion is an adhesion seal having an adhesive layer at least on a conductor-side surface.

In this configuration, the projecting portion is positioned by simply performing adhesion with the adhesive layer, and the projecting portion can be easily formed.

(8) The projecting portion is formed by a liquid gasket.

In this configuration, the projecting portion is positioned by simply adhering the liquid gasket, and the projecting portion can be easily formed.

(9) The bipolar storage battery includes multiple layers of the bipolar electrodes described above.

A bipolar storage battery capable of achieving both long-term reliability and high energy density can be provided.

Here, the entire contents of Japanese Patent Application No. 2020-204830 (filed on Dec. 10, 2020), the present application claiming priority based on the application, are incorporated into the present disclosure by reference. Although herein a description is given with reference to a limited number of embodiments, the scope of right is not limited to those, and modifications of each embodiment based on the above disclosure are self-evident to those skilled in the art.

The following is a list of reference signs used in this specification and in the drawings.
1 Bipolar lead-acid battery
11 External frame
12 Internal frame
12A Base plate (bipolar plate)
12B Frame member (rim)
12a Through hole
20 Electrolyte layer
30 Adhesion layer
31 Adhesion layer
40 Conductor
41 Projecting portion
42 Projecting portion
101 Positive electrode lead layer
102 Negative electrode lead layer
103 Positive active material layer
104 Negative active material layer
110 Negative electrode
120 Positive electrode
130 Bipolar electrode

What is claimed is:

1. A bipolar electrode for a bipolar storage battery, comprising:
a bipolar plate in which a conduction through hole is formed;
a positive electrode stuck to a first surface of the bipolar plate with an adhesion layer; and
a negative electrode stuck to a second surface of the bipolar plate with an adhesion layer, wherein:
the bipolar electrode includes a conductor disposed in the conduction through hole of the bipolar plate, a first bonding portion to which the positive electrode is electrically bonded on a first surface of the conductor, and a second bonding portion to which the negative electrode is electrically bonded on a second surface of the conductor, and
the conductor has a projecting portion surrounding a periphery of the bonding portion on each of the first surface and the second surface.

2. The bipolar electrode according to claim 1, wherein the projecting portion is formed integrally with the conductor.

3. The bipolar electrode according to claim 1, wherein the projecting portion is a part separate from the conductor and adheres to the surface of the conductor.

4. The bipolar electrode according to claim 3, wherein the projecting portion is an adhesion seal having an adhesive layer at least on a surface facing the conductor.

5. The bipolar electrode according to claim 3, wherein the projecting portion is formed by a liquid gasket.

6. The bipolar electrode according to claim 1, wherein the bipolar electrode is a bipolar electrode for a bipolar lead-acid battery.

7. A bipolar storage battery comprising the bipolar electrode according to claim 1.

8. The bipolar electrode according to claim 1, wherein the adhesion layer is formed by curing a liquid adhesive.

9. The bipolar electrode according to claim 8, wherein a height of the projecting portion is more than or equal to a thickness of the adhesion layer.

10. The bipolar electrode according to claim 8, wherein the projecting portion is formed integrally with the conductor.

11. The bipolar electrode according to claim 8, wherein the projecting portion is a part separate from the conductor and adheres to the surface of the conductor.

12. The bipolar electrode according to claim 8, wherein the bipolar electrode is a bipolar electrode for a bipolar lead-acid battery.

13. The bipolar electrode according to claim 1, wherein a height of the projecting portion is more than or equal to a thickness of the adhesion layer.

14. The bipolar electrode according to claim 13, wherein the projecting portion is formed integrally with the conductor.

15. The bipolar electrode according to claim 13, wherein the projecting portion is a part separate from the conductor and adheres to the surface of the conductor.

16. The bipolar electrode according to claim 13, wherein the bipolar electrode is a bipolar electrode for a bipolar lead-acid battery.

17. The bipolar electrode according to claim 13, wherein the projecting portion has a height between 20 μm and 500 μm, inclusive.

18. The bipolar electrode according to claim 17, wherein the projecting portion is formed integrally with the conductor.

19. The bipolar electrode according to claim 17, wherein the projecting portion is a part separate from the conductor and adheres to the surface of the conductor.

20. The bipolar electrode according to claim 17, wherein the bipolar electrode is a bipolar electrode for a bipolar lead-acid battery.
